(19) United States
(12) Patent Application Publication
(10) Pub. No.: US 2024/0174372 A1
(43) Pub. Date: May 30, 2024

(54) DETERMINING BENDING STATE OF AIRCRAFT WING

(71) Applicant: Airbus Operations Limited, Bristol (GB)

(72) Inventor: Dylan Vignola, Bristol (GB)

(21) Appl. No.: 18/522,340

(22) Filed: Nov. 29, 2023

(30) Foreign Application Priority Data
Nov. 29, 2022 (GB) 2217949.3

(51) Int. Cl. B64D 37/00; B64C 3/34

(52) U.S. Cl. CPC B64D 37/005; B64C 3/34

(57) ABSTRACT

An aircraft including a wing, a first pressure sensor and a second pressure sensor, wherein each pressure sensor is configured to measure pressure of a liquid within the wing and has a known position within the wing. The aircraft includes a processing system configured to receive first pressure data from the first pressure sensor, receive second pressure data from the second pressure sensor, and determine a bending state of the wing based on the first pressure data, the second pressure data, and the known positions of the first and second pressure sensors within the wing.

### TECHNICAL FIELD

The disclosure herein relates to an aircraft, an aircraft wing monitoring arrangement, and a method of determining a bending state of a wing of an aircraft.

### BACKGROUND

During flight an aircraft wing has different external loads acting upon it, which cause the wing to bend. For example, the lift of the wing results in an upward force, and the weight of the wing and fuselage results in a downward force. This bending of the wing may cause fatigue and stress in the wing.

### SUMMARY

By way of a non-limiting overview, a system is disclosed with at least two pressure sensors at known positions within a tank within a wing. Pressure sensors monitor the pressure of the liquid within the tank and by using the difference in pressure between the two pressure sensors, it is possible to determine the height between the two pressure sensors. By comparing the heights between the two pressure sensors and their known positions it is possible to determine how much the wing has bent, i.e. the bending state of the wing.

A first aspect of the disclosure herein provides an aircraft comprising: a wing; a first pressure sensor and a second pressure sensor, wherein each pressure sensor is configured to measure pressure of a body of liquid within the wing at a respective measurement point at a known position within the wing; and, a processing system configured to: receive first pressure data from the first pressure sensor; receive second pressure data from the second pressure sensor; and determine a bending state of the wing based on the first pressure data, the second pressure data, and the known positions within the wing.

The aircraft of the first aspect enables real time monitoring of the bending state of the wing across an aircraft's life. In addition, it allows for a more accurate study of fatigue in the wing. It may also be able to capture live wing movements (due to wing flutter and turbulence detection) which can assist flight controls in real-time load alleviation.

Optionally the known positions are spaced apart along a span of the wing.

Optionally the first and second pressure sensors are attached to a bottom skin of the wing.

Optionally the processing system is further configured to determine a volume or mass of the body of liquid based on the first pressure data and the second pressure data.

Optionally the aircraft further comprises: a first reference pressure sensor and a second reference pressure sensor each configured to measure a reference liquid pressure at a reference position; wherein the processing system is further configured to: receive first reference pressure data from the first reference pressure sensor; receive second reference pressure data from the second reference pressure sensor; determine a reference density based on a reference distance between the reference positions, the first reference pressure data, and the second reference pressure data; and determine the bending state of the wing based on the reference density. The reference liquid pressure may be a pressure of the body of liquid within the wing, or pressure of another body of liquid.

Optionally the wing extends in a spanwise direction away from a fuselage at a root end to a wing tip, and the first reference pressure sensor and the second reference pressure sensor are positioned either within: the fuselage; or the wing from the root end to 10% of the distance from the root end to the wing tip.

Optionally the aircraft further comprises a sensor configured to measure an acceleration of the aircraft, wherein the processing system is further configured to determine the bending state based on the measured acceleration of the aircraft.

Optionally the aircraft further comprises a sensor configured to measure an attitude of the aircraft, wherein the processing system is further configured to determine the bending state based on the measured attitude of the aircraft.

Optionally the processing system is configured to determine the bending state of the wing by determining a distance from each measurement point to a reference plane of the aircraft.

Optionally the first pressure data and the second pressure data each comprise a series of pressure readings over a time period.

Optionally the body of liquid is contained in a liquid tank.

Optionally the body of liquid is a body of fuel.

Optionally the aircraft further comprises: one or more further pressure sensors, wherein each further pressure sensor is configured to measure pressure of the body of liquid within the wing at a respective measurement point at a further known position within the wing, and wherein optionally the further known positions of the further pressure sensors are outboard of the known positions of the first and second pressure sensors; wherein the processing system is configured to: receive further pressure data from the further pressure sensor(s); and determine the bending state of the wing based on the further pressure data.

Optionally the aircraft further comprises a memory storing the known positions of each pressure sensor within the wing, wherein the processing system is configured to read the known positions of each pressure sensor within the wing in order to determine the bending state of the wing.

A further aspect of the disclosure herein provides a method of determining a bending state of a wing of an aircraft, the wing containing a body of liquid, the method comprising: obtaining first pressure data by measuring pressure of the body of liquid at a first measurement point at a first known position within the wing; obtaining second pressure data by measuring pressure of the body of liquid at a second measurement point at a second known position within the wing; and determining a bending state of the wing based on the first pressure data, the second pressure data, and the known positions within the wing.

Optionally the method further comprises: obtaining first reference pressure data indicative of a liquid pressure at a first reference position; obtaining second reference pressure data indicative of a liquid pressure at a second reference position; determining a reference density based on the first reference pressure data, the second reference pressure data, and a reference distance between the reference positions; and determining the bending state of the wing based on the reference density.

Optionally the method further comprises measuring an acceleration of the aircraft, wherein the bending state is further determined based on the measured acceleration of the aircraft.

Optionally the method further comprises further comprising measuring an attitude of the aircraft, wherein the bending state is further determined based on the measured attitude of the aircraft.

Optionally the method further comprises: obtaining further pressure data by measuring pressure of the body of liquid at one or more further measurement points at one or more further known positions within the wing, wherein optionally the further known positions are outboard of the first and second known positions; and determining the bending state of the wing based on the further pressure data.

A further aspect of the disclosure herein provides an aircraft wing monitoring arrangement comprising: pressure sensors configured to generate pressure data by measuring pressure of a liquid in an aircraft wing; and a system configured to determine a bending state of the aircraft wing based on the pressure data.

### BRIEF DESCRIPTION OF THE DRAWINGS

Embodiments of the disclosure herein will now be described with reference to the accompanying drawings noted below.

FIG. 1 shows a plan view of an aircraft;

FIG. 2 shows the aircraft of FIG. 1 with a plane of symmetry and a reference plane shown;

FIG. 3 shows a cross-sectional view of a fuel tank in the starboard wing of the aircraft of FIG. 1 in a first bending state;

FIG. 4 shows the fuel tank of FIG. 3 in a second bending state;

FIG. 5 shows a cross-sectional view of the starboard wing of the aircraft of FIG. 1 in an alternative embodiment with two fuel tanks, in a first bending state;

FIG. 6 shows the fuel tanks of FIG. 5 in a second bending state;

FIG. 7 shows a flow diagram of a method of determining a bending state of a wing of an aircraft; and

FIG. 8 shows an aircraft wing monitoring arrangement configured to implement the method of FIG. 7.

### DETAILED DESCRIPTION

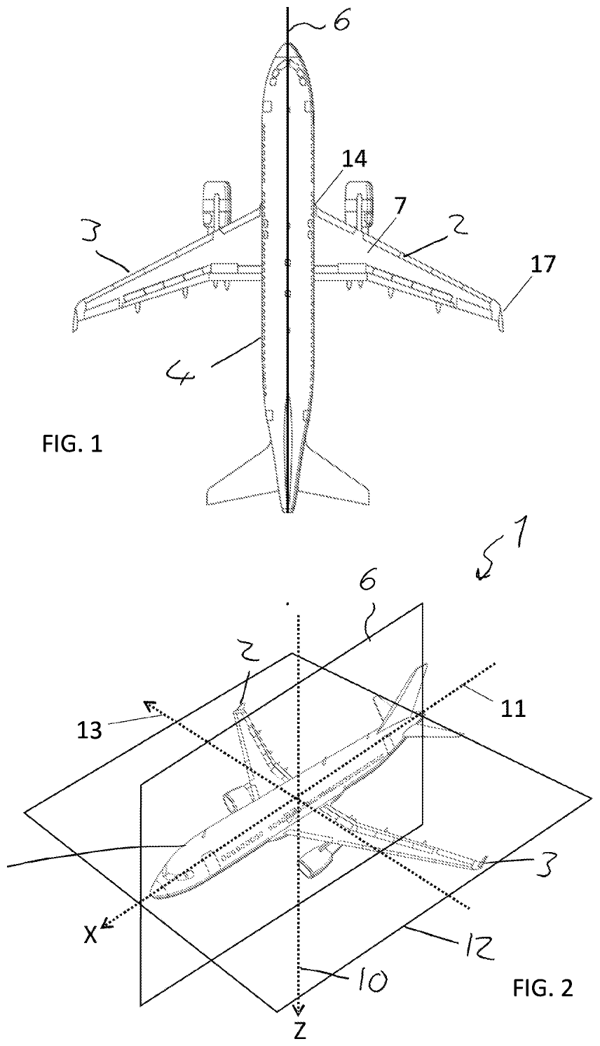

FIG. 1 shows a plan view of an aircraft 1, the aircraft comprises a starboard wing 2, a port wing 3, and a fuselage 4. Each wing 2, 3 is connected to the fuselage 4 of the aircraft 1 at a respective root end. A plane of symmetry 6 of the aircraft 1 is shown.

FIG. 2 shows an isometric view of the aircraft 1 with the plane of symmetry 6 and a reference plane 12 shown. The aircraft also has a yaw axis 10, a roll axis 11 and a pitch axis 13 which define an XYZ frame of reference of the aircraft. The XYZ frame of reference of the aircraft comprises an X-axis aligned with the roll axis 11, a Y-axis aligned with the pitch axis 13, and a Z-axis aligned with the yaw axis 10.

The reference plane 12 is perpendicular to the yaw axis 10 and perpendicular to the plane of symmetry 6. In terms of the XYZ frame of reference the reference plane 12 is the XY plane. The reference plane 12 is horizontal when the aircraft is level (i.e. on the ground or in level flight with zero roll angle and zero pitch angle) and tilts from the horizontal when the aircraft rolls (i.e. rotates about the roll axis 11) or pitches (i.e. rotates about the pitch axis 13).

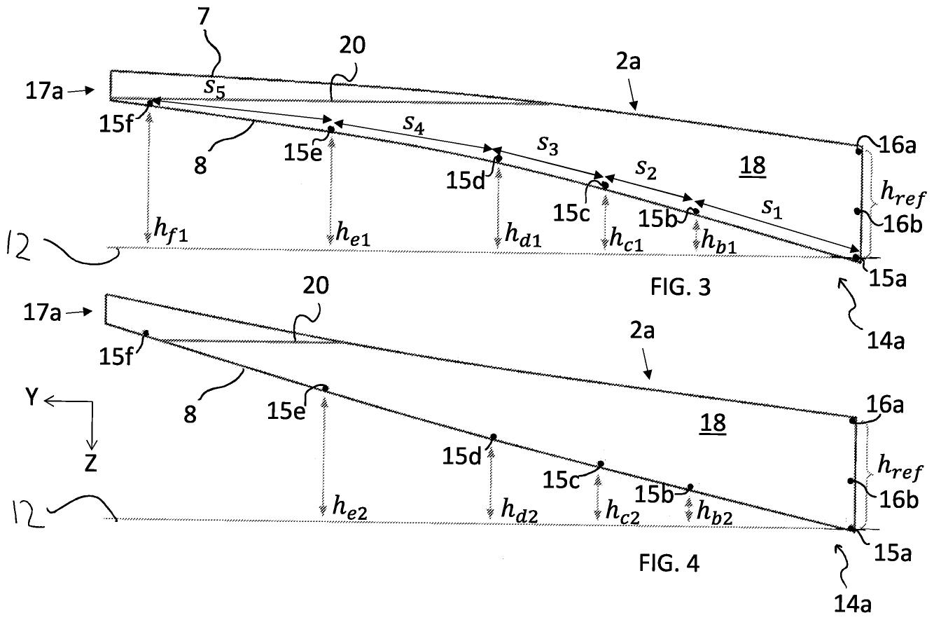

FIGS. 3 and 4 show a cross-sectional view of a fuel tank 2a in the starboard wing 2 of the aircraft 1, viewed in the direction of the roll axis 11. As shown in FIG. 1, the wing 2 extends in a spanwise direction away from the fuselage 4 at a root end 14 to a wing tip 17. The root end 14 of the wing 2 connects to the fuselage 4. The wing 2 has a top skin 7 shown in FIGS. 1 and 3, and a bottom skin 8 not visible in FIG. 1 but labelled in FIG. 4.

The fuel tank 2a extends along a majority of the span of the wing, from an inboard end 14a at the root end 14 of the wing to an outboard end 17a near the wing tip 17. The top wall of the fuel tank 2a is the top skin 7 of the wing, and the bottom wall of the fuel tank is the bottom skin 8 of the wing. The front and rear walls of the fuel tank 2a are provided by spars (not shown). The fuel tank 2a may also contain baffles or be smaller than the whole length of the wing to mitigate sloshing.

FIG. 3 shows pressure sensors 15a, 15b, 15c, 15d, 15e, 15f, 16a, 16b fixed within the fuel tank 2a at known positions. Each pressure sensor is configured to measure the pressure of a body of fuel 18 within the fuel tank 2a at a respective measurement point. The pressure sensors 15a, 15b, 15c, 15d, 15e, 15f, 16a, 16b may have a sensitivity in the range of 100 to 1000 pascals, which enables a height change of the order of 1-10 cm to be detected. The body of fuel 18 has a surface 20.

The pressure sensors 15a-15f are spaced apart along the span of the wing, ranging from a first pressure sensor 15a at (or near) the inboard end 14a of the fuel tank, to a pressure sensor 15f at (or near) near the outboard end 17a of the fuel tank. The known spanwise distances s₁, s₂, s₃, s₄, s₅ between each pair of pressures sensors are indicated in FIG. 3. This allows for the bending state in a spanwise direction of the wing 2 to be determined.

When the aircraft is on the ground with a full load of fuel, the wing may adopt a first bending state shown in FIG. 3 in which it is bent down slightly. During flight of the wing, aerodynamic lift forces acting on the wing may cause it to bend upwards to the second bending state of FIG. 4. During flight of the aircraft, the level of the fuel 18 drops so there is less weight to counteract the aerodynamic lift forces, and the wing 2 may become more upwardly bent compared with FIG. 4. Thus, the wing goes through a series of cycles of bending and unbending during the course of a series of flights. Over a long series of flights, it is desirable to monitor the bending state of the wing in order to assess the risk of fatigue damage.

The pressure sensors 15a, 15b, 15c, 15d, 15e, 15f are preferably attached to the bottom skin 8 of the wing 2 as shown. This allows for pressure monitoring at low fuel levels, because the pressure sensors 15a, 15b, 15c, 15d, 15e, 15f will be submerged for longer and be able to provide more pressure data (when compared to hypothetical pressure sensors at a corresponding distance away from the wing tip which are not attached to the bottom skin 8 of the wing 2).

As shown in FIG. 3, the first pressure sensor 15a lies in the reference plane 12 and is submerged in the body of fuel 18. Therefore, the first pressure sensor 15a may provide pressure data comprising a first pressure reading of the body of fuel 18. A second pressure sensor 15b also submerged in the body of fuel 18 may provide pressure data comprising a second pressure reading of the body of fuel 18. By receiving the pressure readings from the first and second pressure sensors 15a, 15b, and with knowledge of the positions of the first and second pressure sensors 15a, 15b within the wing, it is possible to determine a bending state of the wing 2.

Each pressure sensor is spaced by a distance perpendicular from the reference plane 12, the distance being labelled h_{b1}, h_{c1}, h_{d1}, hₑ₁, h_{f1} in FIG. 3.

When the reference plane 12 is horizontal as in FIG. 3, then each distance h_{b1}, h_{c1}, h_{d1}, hₑ₁, h_{f1} is also a height.

The bending state is determined using the working principle:

P=ρah+P₀ (1)

where P is a first pressure reading (for example from the first pressure sensor 15a), P₀ is a second pressure reading (for example from the second pressure sensor 15b), ρ is the density of the fuel 18, a is acceleration and h is a height difference between the pressure sensors in the direction of the acceleration vector. In the case of a level and non-accelerating aircraft, the acceleration a is the acceleration due to gravity, which is parallel to the yaw axis 10.

When the reference plane 12 is horizontal and the first pressure sensor 15a lies in the reference plane 12, as in FIG. 3, then the height difference between the first and second pressure sensors 15a, 15b is the distance h_{b1} of the second pressure sensor 15b from the reference plane 12.

The equation (1) may be rearranged to make h the subject of the equation:

$$h = \frac{P - {P}_{0}}{ρ a} \qquad ( 2 )$$

The density ρ of the body of fuel 18 may be known, and a may be assumed to be only the acceleration under gravity (9.81 m/s) in a simple scenario. Therefore, the height difference h between the pressure sensors may be calculated using equation (2).

In the case of the first and second pressure sensors 15a, 15b this enables the distance of the second pressure sensor 15b from the reference plane 12 to be determined. The distance of the second pressure sensor 15b from the reference plane 12 increases from h_{b1} in the first bending state of FIG. 3 to h_{b2} in the second bending state of FIG. 4. Hence the pressure readings can be used to infer the bending state of the wing 2.

Two pressure sensors, particularly placed close together at the root of the wing, may not be sufficient to understand the full bending state of the wing, therefore this may be improved by the further pressure sensors (e.g., 15c, 15d, 15e, 15f) spaced apart along the span of the wing 2 as shown in FIG. 3. The pressure sensors 15a, 15b, 15c, 15d, 15e, 15f shown in FIG. 3 can be used to define the bending state of the wing 2 as a polygonal curve with six points, with a spanwise distance s₁, s₂, s₃, s₄, s₅ between the adjacent pairs of points. Each point relates to a measurement point of one of the pressure sensors 15a, 15b, 15c, 15d, 15e, 15f which have a distance 0, hₚ₁, h_{c1}, h_{d1}, hₑ₁, h_{f1} perpendicular to the reference plane 12, respectively.

The number of pressure sensors is arbitrary. The more sensors, the more information about the bending state can be obtained.

If the spanwise distance between adjacent pressure sensors (e.g., 15a, 15b) is small, then the height difference between the adjacent pressure sensors will also be small. This may beneficially provide improved granularity but the usefulness of measurements from the adjacent sensors may be limited by their pressure sensitivity and sensor noise.

The density ρ of the body of fuel 18 may not be known accurately and may also vary depending on temperature. Therefore, reference pressure sensors 15a, 16a, 16b may be provided for continuously determining the density of the fuel 18 during flight of the aircraft.

The reference pressure sensor 16a is mounted at the top of the fuel tank, and the reference pressure sensor 15a is mounted at the bottom of the fuel tank. The sensors 15a, 16a are spaced apart in the Z-direction so they are vertically spaced apart when the aircraft is level (i.e. in a zero-roll and zero pitch situation). Each reference pressure sensor is configured to measure a reference liquid pressure at a reference position, with the reference pressure sensors 15a, 16a spaced apart by a known reference distance h_{ref}.

The reference pressure sensors 15a, 16a are located at the inboard end 14a of the fuel tank, near the wing root, so they do not move relative to each other as the wing changes its bending state, and hence the reference distance h_{ref} does not change as the wing changes its bending state.

It is preferable to maximise the reference distance h_{ref} to improve the accuracy of the calculated density ρ. If the first reference pressure sensor 15a generates first reference pressure data P_{ref1}, and the second reference pressure sensor 16a generates second reference pressure data P_{ref2}, then rearranging equation (1) to make the density ρ the subject of the equation results in:

$$ρ = \frac{{P}_{ref 1} - {P}_{ref 2}}{{h}_{ref} * a} \qquad ( 3 )$$

Therefore, a reference density can be determined using equation (3) based on the first reference pressure data P_{ref1}, the second reference pressure data P_{ref2}, and a known reference distance between the reference pressure sensors.

The reference density from equation (3) can then be used in equation (2) to determine the distances h_{b1}, h_{c1}, h_{d1}, hₑ₁, h_{f1} to the reference plane 12 and hence the bending state of the wing.

Optionally, the reference pressure sensors 15a, 16a, 16b may be positioned in a center tank (not shown) within the fuselage 4, or within the fuel tank 2a but spaced further outboard than in FIG. 3—for instance up to 10% of the spanwise distance from the root end 14 to the wing tip 17 (although this may degrade the accuracy of the system).

The volume of the body of fuel 18 will reduce during the flight of the aircraft 1. If the second reference pressure sensor 16a is no longer submerged, then a third reference pressure sensor 16b may be used instead to determine the fuel density ρ.

Once the third reference pressure sensor 16b is no longer submerged, then the last known calculated density of the fuel may be used for the remainder of the flight. Alternatively, if temperature measurements are available from a temperature sensor on the aircraft, then a correlation of temperature measurements to the density of the fuel may be recorded during the flight e.g., as a temperature-density curve. Therefore, once the third reference pressure sensor 16b is no longer submerged then the density of the fuel may be assumed to follow the determined correlation of temperature to density (e.g., the temperature-density curve of the liquid). Therefore, the density of the fuel may be calculated based on the temperature reading of the temperature sensor.

If it is contained in the same body of fuel 18 as the other pressure sensors 15b-15f, as shown in FIG. 3, then the pressure sensor 15a may be used for both height determination and density determination.

In the equations (2) and (3) above it can be assumed that the acceleration a is known and does not change (i.e. it is the acceleration due to gravity). However, to make the measurement system more accurate during flight of the aircraft 1, an acceleration reading (by an accelerometer) of the acceleration of the aircraft 1 may be used to compensate for acceleration of the aircraft.

If the aircraft is accelerating, then an acceleration of the aircraft may be determined by an appropriate sensor, and an appropriate correction applied to determine a total acceleration vector for use in equation (2) and/or equation (3).

For example, the sensor may be a three-axis accelerometer which outputs acceleration components ax, ay, az aligned with the XYZ frame of reference of the aircraft, and these can be used to calculate the magnitude and direction of the acceleration vector a in equation (2) and/or equation (3). The three-axis accelerometer may be provided by an inertial reference system of the aircraft.

In the equations (2) and (3) above it can be assumed that the attitude of the aircraft is level (i.e. at zero pitch and zero roll). However, to make the measurement system more accurate during flight of the aircraft 1, an attitude reading may be used to compensate for a change in pitch or roll angle. The attitude reading may be provided by a dedicated sensor, or by the previously mentioned inertial reference system of the aircraft.

The accuracy of determining a bending state may be improved by providing three or more pressure sensors (e.g., 15a, 15b, 15c, 15d, 15e, 15f) spaced apart along the span of the wing 2 as shown in FIGS. 3 and 4. As the wing 2 bends and/or the body of fuel 18 is reduced, pressure sensors (e.g., 15a, 15b, 15c, 15d, 15e, 15f) starting from the wing tip 17 end may no longer be able to measure a pressure of the body of fuel 18. Therefore, providing three or more pressure sensors (e.g., 15c, 15d, 15e, 15f) spaced apart along a span of the wing 2 can improve the accuracy of a determined bending state of the wing 2 over a period of time.

The bending state of the wing 2 shown in FIG. 4 results in the body of fuel 18 no longer submerging a pressure sensor 15f resulting in the pressure sensor 15f being unable to measure pressure of the liquid. In this case only the remaining submerged pressure sensors 15a, 15b, 15c, 15d, 15e may be used.

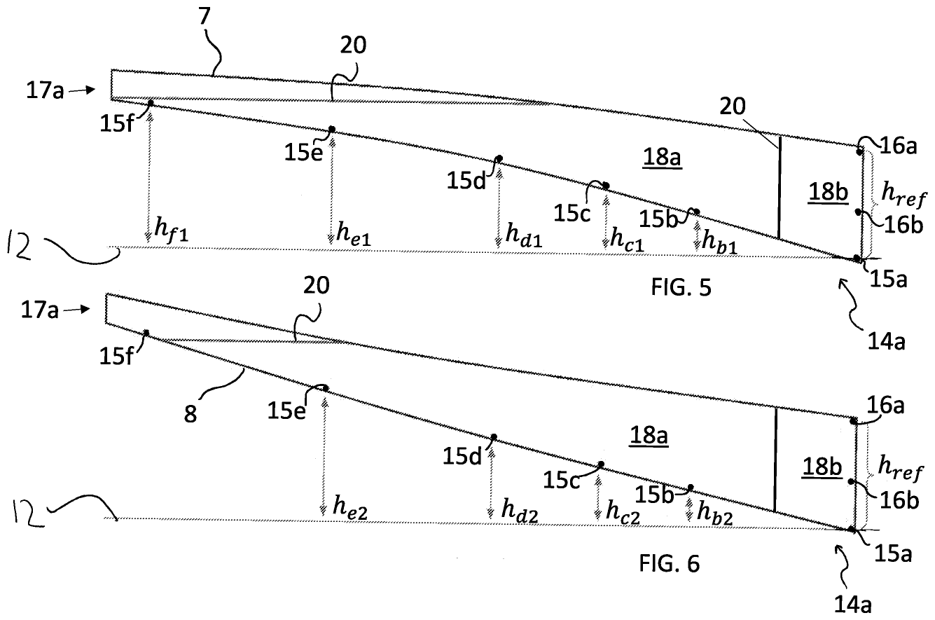

FIGS. 5 and 6 show an alternative fuel tank arrangement within the wing 2. Most elements of FIGS. 5 and 6 are the same as in FIGS. 3 and 4, and the same reference numbers are used accordingly.

In FIGS. 5 and 6 the wing contains two fuel tanks: an outboard fuel tank containing a first body of fuel 18a and the pressure sensors 15b-15f, and an inboard fuel tank containing a second body of fuel 18b and the reference pressure sensors 15a, 16a, 16b. The tanks are separated by a wall 20 so fuel cannot flow between them.

In this case, unlike in the previous embodiment, the pressure sensor 15a can only be used as a reference pressure sensor (to determine fuel density) because it is in a different body of fuel to the pressure sensors 15b-15f.

The arrangement of FIGS. 5 and 6 assumes that the second body of fuel 18b has substantially the composition and temperature as the first body of fuel 18a, so the density measurement of the second body of fuel 18b can be used to infer the density of the first body of fuel 18a, and hence used for the purposes of determining the bending state of the wing 2. If this assumption is not valid, then the reference pressure sensors should be in the same body of liquid as the other pressure sensors, as in FIGS. 3 and 4.

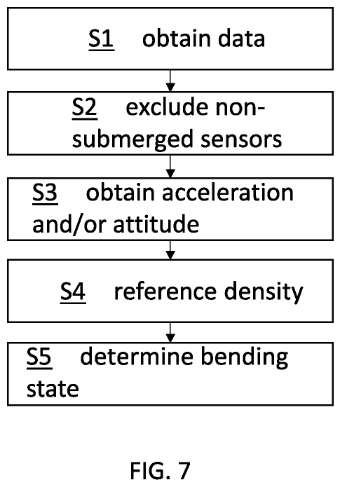

FIG. 7 shows a flow diagram of a method of determining a bending state of the wing 2 of the aircraft 1, the wing of the aircraft containing a body of fuel 18 and comprising at least a first pressure sensor 15a and a second pressure sensor 15b as shown in FIGS. 3-7. The method of FIG. 7 is computer implemented.

Step S1 of the method obtains pressure data from all applicable sensors. This includes first pressure data obtained from the first pressure sensor 15a by measuring pressure of the body of fuel 18 at a first known position within the wing, second pressure data obtained from the second pressure sensor 15b by measuring pressure of the body of fuel 18 at a second known position within the wing, and further pressure data obtained from one or more further pressure sensors 15c, 15d, 15e, 15f, by measuring pressure of the body of fuel 18 at one or more further known positions within the wing.

Each one of the further pressure sensors 15c, 15d, 15e, 15f is progressively closer to the wing tip than the first and second pressure sensors 15a, 15b, so the further known positions are outboard of the first and second known positions.

Step S2 determines which pressure sensors, if any, are not submerged in fuel. Pressure data from these sensors is excluded.

Optional step S3 of the method obtains a total acceleration of the aircraft (from an accelerometer or other sensor) and/or attitude of the aircraft (from the same sensor or a different sensor). Alternatively, step 3 may be omitted and the acceleration a in equation (2) and/or equation (3) assumed to be the acceleration due to gravity in the direction of the yaw axis 10 of the aircraft.

Optional step S4 of the method obtains first reference pressure data from the first reference pressure sensor 15a at a first known reference position, and second reference pressure data from the second reference pressure sensor 16b at a second known reference position. In addition, the step S4 also determines a reference density of the body of fuel 18 based on the known reference position of the first reference pressure sensor, the known reference position of the second reference pressure sensor, the first reference pressure data, and the second reference pressure data.

Step S5 of the method determines a bending state of the wing based on the pressure data not excluded in step S2, and the known positions of the pressure sensors within the wing. Optionally the bending state is also determined based on the total acceleration and/or attitude obtained in step S3 and/or the reference density from step S4.

As mentioned above, each pressure sensor is configured to measure pressure of the body of fuel 18 within the wing at a measurement point at a known position within the wing. The pressure sensors 15a-15f are spaced apart along the span of the wing, with known spanwise distances s₁, s₂, s₃, s₄, s₅ between each pair of pressures sensors as indicated in FIG. 3. Hence the pressure sensor 15b is configured to measure pressure at a first measurement point with a known spanwise position s₁ within the wing, the pressure sensor 15c is configured to measure pressure at a second measurement point with a known spanwise position s₁+s₂ within the wing, and so on. The bending state of the wing may be defined by the calculated distances h_{b1}, h_{c1}, h_{d1}, hₑ₁, h_{f1} from the measurement points to the reference plane 12, and the known spanwise positions of the measurement points.

Each pressure sensor 15a-15f provides pressure data as a series of pressure readings over a time period. The bending state may then be determined for each of the series of pressure readings to provide a series of bending states of the wing 2 over the time period. The series of bending states may enable monitoring of wing bending over a flight of the aircraft 1.

Each of the series of pressure readings over the time period may be provided to a filter such as a low pass filter. The low pass filter will filter out high frequency fluctuations which will reduce the effect of sensor noise.

Each of the series of pressure readings may be taken at a sampling rate. The sampling rate may be suitable for monitoring the effects of high frequency events on the wing 2 (such as turbulence or wing flutter). A suitable sampling rate may be less than one sample per five seconds. A suitable sampling rate may be determined by 1 over 2 times the desired maximum frequency to be observed, in other words 1/nyquist frequency of the desired frequency range.

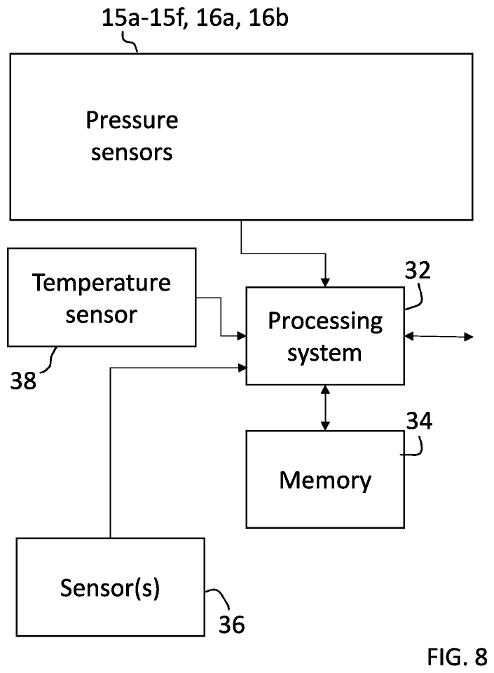

FIG. 8 shows an aircraft wing monitoring arrangement configured to implement the method described in FIG. 7. The system comprises the pressure sensors 15a-15f, 16a, 16b, a processing system 32, a memory 34, an aircraft sensor (or sensors) 36 (such as a 3-axis accelerometer and/or a dedicated attitude sensor) and a temperature sensor 38.

The processing system 32 is configured to receive the pressure data from the pressure sensors 15a-15f, 16a, 16b; and determine a bending state of the wing based on the pressure data and the known positions within the wing of the pressure sensors (and their associated pressure readings).

Optionally the processing system 32 is further configured to improve the accuracy of the determined bending state by using data from the temperature sensor 38 and/or the aircraft sensor(s) 36 as described above.

Optionally the processing system 32 is further configured to determine a volume or mass of the body of fuel 18, 18a based on the pressure data.

The system of FIG. 8 may be entirely hosted onboard the aircraft 1 or it may be a distributed system whereby pressure, temperature, and acceleration data are recorded by the aircraft onboard computers and collected regularly to be post-processed in a land-based computer system remote from the aircraft 1 to determine a bending state of the wing. As such the processing system 32 may be any type of processing device (or network of devices) such as, a computer of the aircraft 1, a desktop PC, a server, or multiple processors etc. For example, the pressure sensors may be coupled to a memory 34 (e.g., via a distinct processor/controller) in order to store a record of the pressure data throughout the flight of the aircraft 1, and then later post-flight analysis may be conducted via an external processor to determine one or more bending states of the wing 2. In addition, the processing system 32 may be coupled to further components. For example, if the processing system 32 is onboard the aircraft 1, then the processing system 32 may be coupled to flight control surfaces for load alleviation. The flight surfaces may then be controlled to compensate for (or alter) the bending state of the wing 2.

If the processing of the data is moved to a remote land-based system, then the load alleviation function will not be available.

The memory 34 may be used to store pressure data, temperature data, attitude data and acceleration data received either directly from the sensors 15a-15f, 16a, 16b, 36, 38 or via the processing system 32. The memory 34 may be volatile or non-volatile memory, and may store instructions for operating the processing system 32 in accordance with the method described at least at FIG. 7.

The memory 34 may store further known data such as, a density of the fuel, a temperature-density curve of the fuel, an acceleration under gravity, the known positions of each pressure sensor within the wing, etc.

The processing system 32 may be configured to read the known positions of each pressure sensor within the wing from the memory 34 in order to determine and output the bending state of the wing.

The sensor (or sensors) 36 may comprise a 3-axis accelerometer arranged to measure acceleration of the aircraft 1 in its local frame of reference. The sensors (or sensors 36) may be provided by an inertial reference system of the aircraft.

The accelerometer may be in the fuselage 4, the wing 2, or any other part of the aircraft 1. The sensor (or sensors) 36 provide(s) acceleration data and/or attitude data to the processing system 32 and/or the memory 34.

The temperature sensor 38 is arranged to measure temperature either of the body of fuel 18, 18a, 18b or any other part of the aircraft 1 from which the temperature of the body of fuel 18, 18a, 18b may be estimated. The temperature sensor 38 provides temperature data to the processing system 32 and/or the memory 34. The temperature sensor 38a may be a dedicated sensor or part of any existing aircraft temperature measurement system.

By way of summary, the examples disclosed herein provide fatigue monitoring and management.

The examples provide a solution that may utilize the pressure sensors from an already existing pressure based gauging system to determine the wing bending state, avoiding the need to install dedicated sensors or any other wing bending measurement technology, thus decreasing manufacturing costs and complexity.

In an alternative example, the pressure sensors 15a, 15b, 15c, 15d, 15e, 15f may be attached to a part of the wing 2 other than the bottom skin of the wing 2. This may reduce the availability of the sensors as they may become unsubmerged in fuel earlier in flight.

The pressure sensors may be permanently attached, temporarily attached, or movably attached to the wing 2.

FIGS. 3-6 show pressure sensors 15a, 15b, 15c, 15d, 15e, 15f within a fuel tank containing a liquid hydrocarbon fuel 18, 18a, 18b which is fed to the aircraft engines to provide thrust. In other embodiments of the disclosure herein, the wing 2 may contain a body of a different liquid which is used in a similar way to infer a bending state of the wing. For example, pressure sensors may be distributed within a body of hydraulic liquid within a hydraulic actuation system, or within a body of water or any other liquid.

Optionally, the pressure data from the pressure sensors 15a, 15b, 15c, 15d, 15e, 15f, 16a, 16b may also be used to determine a volume or mass of the body of fuel 18, 18a. Thus, it is possible to use the pressure sensors 15a, 15b, 15c, 15d, 15e, 15f, 16a, 16b for both gauging fuel level and determining a bending state of the wing 2.

Where the word ‘or’ appears this is to be construed to mean ‘and/or’ such that items referred to are not necessarily mutually exclusive and may be used in any appropriate combination.

Although the disclosure herein has been described above with reference to one or more preferred embodiments, it will be appreciated that various changes or modifications may be made without departing from the scope of the disclosure herein as defined in the appended claims.

It should be understood that modifications, substitutions, and alternatives of the invention(s) may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
a wing;
a first pressure sensor and a second pressure sensor, wherein each pressure sensor is configured to measure pressure of a body of liquid within the wing at a respective measurement point at a known position within the wing; and
a processing system configured to:
receive first pressure data from the first pressure sensor;
receive second pressure data from the second pressure sensor; and
determine a bending state of the wing based on the first pressure data, the second pressure data, and the known positions within the wing.

2. The aircraft of claim 1, wherein the known positions are spaced apart along a span of the wing.

3. The aircraft of claim 1, wherein the first and second pressure sensors are attached to a bottom skin of the wing.

4. The aircraft of claim 1, wherein the processing system is further configured to determine a volume or mass of the body of liquid based on the first pressure data and the second pressure data.

5. The aircraft of claim 1, further comprising a first reference pressure sensor and a second reference pressure sensor each configured to measure a reference liquid pressure at a reference position;
wherein the processing system is further configured to:
receive first reference pressure data from the first reference pressure sensor;
receive second reference pressure data from the second reference pressure sensor;
determine a reference density based on a reference distance between the reference positions, the first reference pressure data, and the second reference pressure data; and
determine the bending state of the wing based on the reference density.

6. The aircraft of claim 5, wherein the wing extends in a spanwise direction away from a fuselage at a root end to a wing tip, and the first reference pressure sensor and the second reference pressure sensor are positioned either within the fuselage or within the wing from the root end to 10% of the distance from the root end to the wing tip.

7. The aircraft of claim 1, further comprising a sensor configured to measure an acceleration of the aircraft, wherein the processing system is further configured to determine the bending state based on measured acceleration of the aircraft.

8. The aircraft of claim 1, wherein the processing system is configured to determine the bending state of the wing by determining a distance from each measurement point to a reference plane of the aircraft.

9. The aircraft of claim 1, further comprising a sensor configured to measure an attitude of the aircraft, wherein the processing system is further configured to determine the bending state based on measured attitude of the aircraft.

10. The aircraft of claim 1, wherein the first pressure data and the second pressure data each comprise a series of pressure readings over a time period.

11. The aircraft of claim 1, wherein the body of liquid is contained in a liquid tank.

12. The aircraft of claim 1, wherein the body of liquid is a body of fuel.

13. The aircraft of claim 1, further comprising:
one or more further pressure sensors, wherein each further pressure sensor is configured to measure pressure of the body of liquid within the wing at a respective measurement point at a further known position within the wing, and wherein optionally the further known positions of the further pressure sensors are outboard of the known positions of the first and second pressure sensors;
wherein the processing system is configured to:
receive further pressure data from the further pressure sensor(s); and
determine the bending state of the wing based on the further pressure data.

14. The aircraft of claim 1, further comprising a memory storing the known positions of each pressure sensor within the wing, wherein the processing system is configured to read the known positions of each pressure sensor within the wing to determine the bending state of the wing.

15. A method of determining a bending state of a wing of an aircraft, the wing containing a body of liquid, the method comprising:
obtaining first pressure data by measuring pressure of the body of liquid at a first measurement point at a first known position within the wing;
obtaining second pressure data by measuring pressure of the body of liquid at a second measurement point at a second known position within the wing; and
determining a bending state of the wing based on the first pressure data, the second pressure data, and the known positions within the wing.

16. The method of claim 15, further comprising:
obtaining first reference pressure data indicative of a liquid pressure at a first reference position;
obtaining second reference pressure data indicative of a liquid pressure at a second reference position;
determining a reference density based on the first reference pressure data, the second reference pressure data, and a reference distance between the reference positions; and
determining the bending state of the wing based on the reference density.

17. The method of claim 15, further comprising measuring an acceleration of the aircraft, wherein the bending state is further determined based on the measured acceleration of the aircraft.

18. The method of claim 15, further comprising measuring an attitude of the aircraft, wherein the bending state is further determined based on the measured attitude of the aircraft.

19. The method of claim 15, further comprising obtaining further pressure data by measuring pressure of the body of liquid at one or more further measurement points at one or more further known positions within the wing, wherein optionally the further known positions are outboard of the first and second known positions;
and determining the bending state of the wing based on the further pressure data.

20. An aircraft wing monitoring arrangement comprising pressure sensors configured to generate pressure data by measuring pressure of a liquid in an aircraft wing, and a system configured to determine a bending state of the aircraft wing based on the pressure data.
